(19) United States
(12) Patent Application Publication
(10) Pub. No.: US 2011/0271250 A1
(43) Pub. Date: Nov. 3, 2011

(54) Software Development Tool

(75) Inventors: Deum Jik Park, Kirkland, WA (US); Heejae Chang, Issaquah, WA (US); Theodore Yaung, Seattle, WA (US)

(73) Assignee: Microsoft Corporation, Redmond, WA (US)

(21) Appl. No.: 12/770,790

(22) Filed: Apr. 30, 2010

(51) Int. Cl. G06F 9/45; G06F 9/44

(52) U.S. Cl. 717/113; 717/156

(57) ABSTRACT

A system and method for providing a completion list associated with computer program source code and a dynamic expression. A static analysis is performed to find and aggregate one or more candidate types of the expression. The analysis may include one or more of a number of techniques, including analyzing expressions that are assigned to a program variable, following method calls, examining system or other specified assemblies, loading runtime assemblies, or making inferences based on other uses of the variable. A dynamic analysis may be performed and combined with a static analysis. A completion list may be filtered or ordered based on a configured criteria.

### CROSS-REFERENCE TO RELATED APPLICATIONS

The present invention is related to U.S. patent application entitled “Software Development Tool,” Ser. No. ______, filed concurrently herewith, the contents of which are hereby incorporated by reference herein.

### BACKGROUND

An Integrated Development Environment (IDE) is a set of tools that assist a programmer to develop software. An IDE may include a source code editor, compiler, and debugger. It may include a browser that allows a programmer to view a class hierarchy, information about classes, methods, or other program elements.

An IDE or other programming environment may include an auto-completion feature to assist programmers when entering text. Using an auto-completion feature, a user may type a name of an object that has been defined to be of a specific class, followed by a period. The auto-completion tool may recognize the object's class and provide a list of class members, including fields, properties, and methods. Rather than type the name of a desired class member, the user may select from the list. The tool then inserts the selected member name into the source code. If the user types one or more characters before making a selection, the auto-completion tool may filter the list so that it is limited to matching text. The user may select an item from the list after typing one or more characters.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to generate a completion list corresponding to a program variable that has not been statically declared to have a type. The type of the variable may be resolved during execution of the target program. In one embodiment, a runtime monitor tracks events during execution of the target program code to determine type resolutions of a program variable. For each runtime type resolution, a set of class members associated with the type may be determined and aggregated to form a completion list.

In one embodiment, while in an editing session, a list invocation event causes a list generator to perform a control flow analysis of at least portions of the target program. One or more assignments to the variable may be found. Each expression may be analyzed to determine a candidate type set for the variable. Class members associated with each candidate type, or available from an object of the candidate type, are retrieved and inserted into a completion list.

In one embodiment, uses of the variable may be analyzed to determine one or more candidate types. This may be based on an instruction that invokes a member of the variable object, a use of the variable as an argument to a method where the corresponding parameter has a declared type, use of the variable object as an operand in an expression, or another use of the variable.

In one embodiment, a control flow analysis may lead to an assembly. A compile-time assembly may be analyzed to retrieve candidate types or corresponding members. A runtime assembly may be loaded while in an editing session, and a specified type may be instantiated. Reflection may be used to determine a list of corresponding members.

In one embodiment, the items of the completion list may be ordered based on the runtime type resolutions or the static analysis. The completion list may be filtered to present a completion list having configured criteria, or to present groups of completion list items.

To the accomplishment of the foregoing and related ends, certain illustrative aspects of the system are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 is a block diagram of a computer system in which mechanisms described herein may be implemented;

FIG. 2 illustrates a screen shot of an example editing session in which some mechanisms described herein may be employed;

FIG. 3 illustrates a screen shot of another example editing session in which some mechanisms described herein may be employed;

FIG. 4 illustrates a screen shot of another example editing session in which some mechanisms described herein may be employed;

FIG. 5A illustrates a screen shot of another example editing session in which some mechanisms described herein may be employed;

FIG. 5B illustrates a screen shot of another example editing session in which some mechanisms described herein may be employed;

FIG. 6 illustrates a screen shot of another example editing session in which some mechanisms described herein may be employed;

FIGS. 7A-C illustrate additional screen shots of example editing sessions in which some mechanisms described herein may be employed;

FIG. 8 is a flow diagram illustrating an example embodiment of a process of providing a completion list to a user;

FIG. 9 is a flow diagram illustrating an example embodiment of a process of determining one or more candidate types of a program variable;

FIG. 10 is a flow diagram illustrating an example embodiment of a process of determining a candidate type of a program variable;

FIG. 11 is a flow diagram illustrating an example embodiment of a process of determining a candidate type of a program variable based on a dynamic analysis; and

FIG. 12 shows one embodiment of a computing device, illustrating selected components of a computing device that may be used to perform functions described herein.

### DETAILED DESCRIPTION

Example embodiments of the present invention now will be described more fully hereinafter with reference to the accompanying drawings, which form a part hereof, and which show, by way of illustration, specific example embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to a previous embodiment, though it may. Furthermore, the phrase “in another embodiment” as used herein does not necessarily refer to a different embodiment, although it may. Thus, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “assignment” when referencing a computer program refers to a construct that specifies a value is to be assigned or bound to a specified variable during execution of the program. This may be in the form of a single assignment statement, such as “x=new classX( )”, which specifies the expression “new classX( )” is to be evaluated, and the result assigned to the variable x. It may also be in the form of a method parameter declaration and a corresponding method invocation. For example, in the program code:

void methodA (classY foo);
...
method A(bar);

the construct specifies that the invocation of methodA assigns the object represented by the argument bar to the parameter foo.

As used herein, the term “editing session” refers to an environment in which an editor, viewer, or browser is displaying at least a portion of program source code to a user. An editing session may, but does not necessarily include actions that modify the program source code. Though an editing session may be interleaved with the execution of the target program, or occur concurrently with the execution, or runtime, of the target program, an editing session is distinct from the program runtime and may occur when an executable program corresponding to the target program does not exist. References to actions that occur in an editing session refer to actions that do not employ runtime data structures.

The components described herein may execute from various computer-readable media having various data structures thereon. The components may communicate via local or remote processes such as in accordance with a signal having one or more data packets (e.g. data from one component interacting with another component in a local system, distributed system, or across a network such as the Internet with other systems via the signal). Software components may be stored, for example, on non-transitory computer-readable storage media including, but not limited to, an application specific integrated circuit (ASIC), compact disk (CD), digital versatile disk (DVD), random access memory (RAM), read only memory (ROM), floppy disk, hard disk, electrically erasable programmable read only memory (EEPROM), flash memory, or a memory stick in accordance with embodiments of the present invention.

The term computer-readable media as used herein includes both non-transitory storage media and communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media.

As used herein, the term “application” refers to a computer program or a portion thereof, and may include associated data. An application may be an independent program, or it may be designed to provide one or more features to another application. An “add-in” and a “plug-in” are examples of applications that interact with and provides features to a “host” application.

An application is made up of any combination of application components, which may include program instructions, data, text, object code, images or other media, security certificates, scripts, or other software components that may be installed on a computing device to enable the device to perform desired functions. Application components may exist in the form of files, libraries, pages, binary blocks, or streams of data.

As used herein, unless otherwise indicated by the context, the term “function” refers to a portion of code within a larger program that performs a specific task, and can execute relatively independent of other portions of the program. A function may, but does not necessarily, return a value. In various computer languages, different terms may be used, such as subroutine, method, procedure, or subprogram. As used herein, the term “function” may include all of these.

As used herein, the term “static typing” refers to a programming construct in which a variable type is available at compile time. A static type declaration is an explicit declaration of a variable's type prior to the program runtime. “int foo;” is an example of a static type declaration. The term “dynamic typing” refers to a programming construct in which a variable's type is resolved at runtime. In the C# language, dynamic typing may be specified by using the keyword “dynamic.” For example, the statement “dynamic d1” specifies that the variable d1 is dynamically typed, and that the type will be resolved at runtime. Other languages may use other constructs to specify dynamic typing. In some languages, dynamic typing is the default, or only typing of variables.

As used herein, the term “control flow analysis” refers to a static analysis of a computer program code, which may be source code, intermediate code, or native code, to determine the control flow of the computer program, or portion thereof. The term “dynamic analysis” refers to an analysis that is performed by executing a computer program and observing the program behavior, including execution paths that are taken.

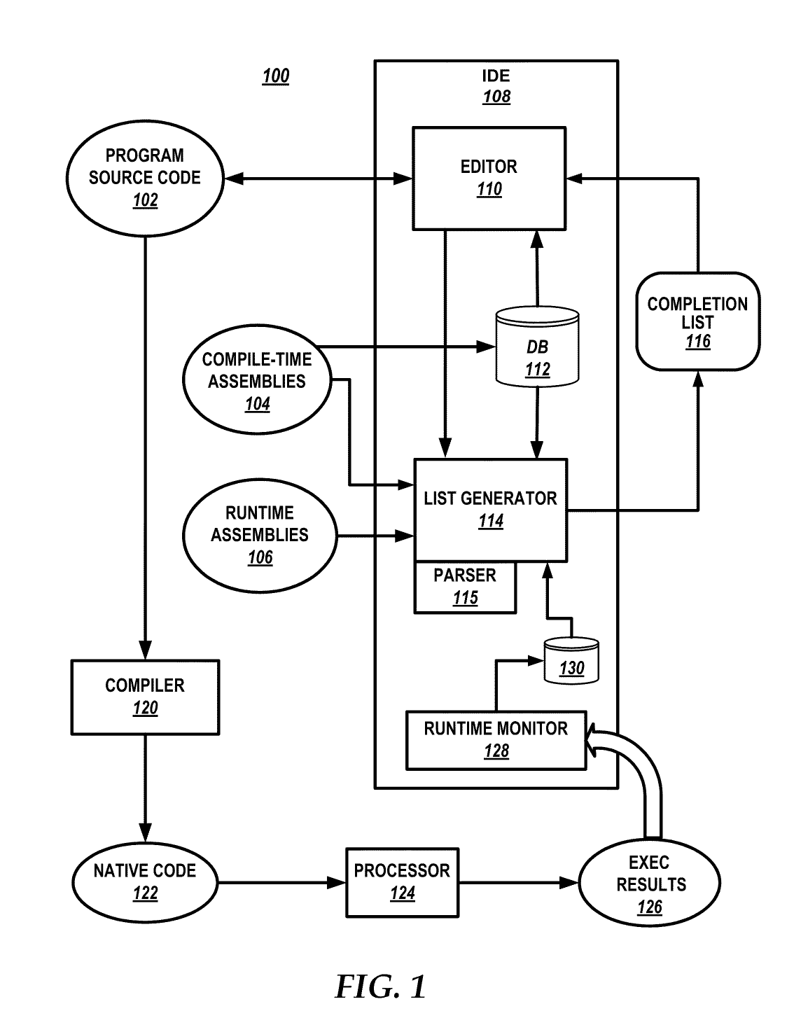

FIG. 1 is a block diagram of a computer system 100 in which mechanisms described herein may be implemented. FIG. 1 is only an example of a suitable system configuration and is not intended to suggest any limitation as to the scope of use or functionality of the present invention. Thus, a variety of system configurations may be employed without departing from the scope or spirit of the present invention.

As illustrated, system 100 includes program source code 102, which may be a high level language representation of a computer program. Examples of a high level language include C-Sharp (C#), C++, Visual Basic, F-Sharp (F#), or various other high level languages. LINQ, which is a combination of a language and a library extension, is another example of program source code 102. Program source code 102 is a representation of a target program that may be edited and executed by system 100. A target program may include one or more functions. A target program may reside in one or more files or other storage representations. A target program may include one or more libraries, which may be integrated or distributed in a variety of ways. Thus, program source code 102 may represent a program library or a portion thereof.

As illustrated, system 100 includes integrated development environment (IDE) 108. IDE 108 may include a variety of tools that assist a programmer to develop software. In the illustrated embodiment, IDE includes editor 110, list generator 114, parser 115, and database 112.

Editor 110 may be a software component that enables a user to view, write, or modify source code. Editor 110 may include a user interface component that displays source code 102 and receives input text and commands from a user. Editor 110 may include a number of features that provide information relating to a computer program or portion thereof, facilitate editing functions, or the like. In some embodiments, editor 110 may include features that indicate syntactical or semantic errors, suggest corrections, or facilitate entering correct program code. In various configurations, functions of editor 110 may be distributed across multiple components or combined with other components of system 100, including those not illustrated.

In one embodiment, editor 110 receives completion list 116 at various times and displays the list. Editor 110 may enable a user to view the list and select an item from the list. In one embodiment, in response to a user selection of an item from the completion list and a user command, a string from the item, or a portion thereof, may be inserted into the displayed portion of program source code. Thus, completion list 116 may serve as an aid in remembering desired text strings and in entering the strings into the editor.

In the illustrated embodiment, list generator 114 may receive a portion of source code 102 from editor 110 and determine a completion list 116, which may then be passed to editor 110. List generator 114 may receive data from database 112 and determine a list of items from database 112, to generate completion list 116. In one configuration, list generator 114 may include or employ parser 115 to perform parsing of source code 102. In some configurations, parser 115 may also be used by editor 110 or compiler 120.

Database 112 may store information including class definitions, member names and data types, method parameters, or the like. It may store identifiers, structure or other information from source code 102. It may also include information from file headers, assemblies, documentation, or other sources. Though database 112 is illustrated as a single database, it may be comprised of multiple databases. Each portion may be stored as a file, maintained in volatile memory, or stored using a variety of mechanisms. Database 112 may be implemented in any of a variety of ways, such as a structured database, a flat file, one or more data structures in memory, a markup language, or any combination thereof. Database 112 may be updated by editor 110, list generator 114, or other components not illustrated in FIG. 1. In one embodiment, database 112 may receive and store information from compile-time assemblies 104 or runtime assemblies 106. An assembly is a program code library, and may contain class definitions, function definitions, or other elements of program code. Compile-time assemblies 104 include assemblies that are part of the current program project, operating system, or software framework, and the contents of the assembly are known or available during an editing session. For example, in the .NET programming environment, .NET assemblies are considered to be compile-time assemblies. Runtime assemblies 106 include assemblies for which the contents are unknown without loading the assembly. These are typically external to the current project, framework, or system.

In the illustrated embodiment, system 100 includes compiler 120, which translates program source code 102 into native code 122. Though compiler 120 is illustrated as a single component, in various embodiments, it may include one or more subcomponents, and may generate one or more intermediate representations of a computer program. For example, in one embodiment, compiler 120 may include a front end that generates an intermediate language representation, and a code generator that translates the intermediate language representation into native code 122. In one configuration, the system may use just-in-time (JIT) compilation. Generally, a JIT compiler employs a mechanism in which an intermediate language representation of a program function is loaded and translated into a native language representation in response to its first invocation.

Native code 122 may be a machine language, a virtual machine language, or another representation that may be executed by a physical or virtual processor. Processor 124 may receive native code 122 and execute program instructions, to produce execution results 126. In one configuration, processor 124 may include one or more central processing units, one or more processor cores, an ASIC, or other hardware processing component and related program logic. In one configuration, processor 124 may include a software component simulating a hardware processing unit. Processor 124 executes instructions in the native code 122. As used herein, the term “runtime” refers to the execution of target program instructions, or libraries, assemblies, or executable files that interact with the target program.

Execution results 126 is a logical representation of the results of executing the native code 122. The results may include one or more of modifications to computer storage or computer memory, communication with other processes or computing devices, audio or video output, or control of various system or external components.

In one embodiment, IDE 108 may include runtime monitor 128, which tracks certain events during runtime of the native code. Some of these events may indicate actual control flow that occurred during one or more executions. Some of these events may indicate the type of objects that are bound to variables, objects, or expressions during runtime. Runtime monitor 128 may store this data in runtime database 130. In one embodiment, completion list generator 114 uses this data to determine candidate types for a target variable or expression, and insert items into completion list 116 based on this.

In accordance with some of the mechanisms described herein, portions of system 100 may operate as follows. A developer may enter a portion of source code 102 within editor 110. An event may invoke list generator 114. List generator 114 may parse a portion of source code 102 using information from database 112, generating completion list 116. In one embodiment, completion list 116 includes context-sensitive choices that may be used to insert text at a current location in editor 110. Editor 110 may receive completion list 116 and display it or a portion thereof. A user may select an item from the completion list and direct the editor to insert the item, or a string corresponding to the item, in source code 102 at a specified location.

In some embodiments, the event that invokes list generator 114 may be any one or more of a number of events. Inserting a character or sequence of characters in editor 110 is one such event. For example, insertion of a period following an object identifier may suggest that a member of the object class is to follow. Insertion of a period may therefore cause editor 110 to invoke list generator 114. As another example, placement of a cursor at a location may cause the editor 110 to selectively invoke list generator 114 based on the context. For example, placement of a cursor immediately following a period that follows an object identifier may be a list invoking event. As another example, a user may explicitly enter a command to invoke list generator 114. This may be performed by typing a key or key combination, selecting a menu item, clicking on a button, deleting text, entering a voice command, or any other way of entering a command using input mechanisms of the computing device. As another example, positioning a mouse pointer over an identifier or other string in editor 110 may cause editor 110 to invoke list generator 114. A list invoking event may be initiated by editor 110, for example, in response to a compilation error. The term “list invoking event” is used herein to refer to an event that invokes list generator 114, and may include any one or more of these examples, or other events.

An example of a use of this feature may be that of a programmer who is entering source code to indicate a reference to a method or variable associated with an object. After entering the object identifier, followed by a period, list generator 114 may create a list containing names of methods that are available to be invoked to the identifier, names of variables associated with the identifier, or a combination thereof. As described herein, in some contexts, list generator 114 may perform some actions to determine a class, or a possible class, corresponding to the object identifier.

System 100 may be a subsystem of a development system. A development system may include one or more computing devices that are used by a program developer or a user as part of a program development, testing, or documentation process. The components of system 100 may be distributed among one or more computing devices, each of which may communicate with the others by employing one or more of various wired or wireless communication protocols such as IP, TCP/IP, UDP, HTTP, SSL, TLS, FTP, SMTP, WAP, Bluetooth, WLAN, or the like.

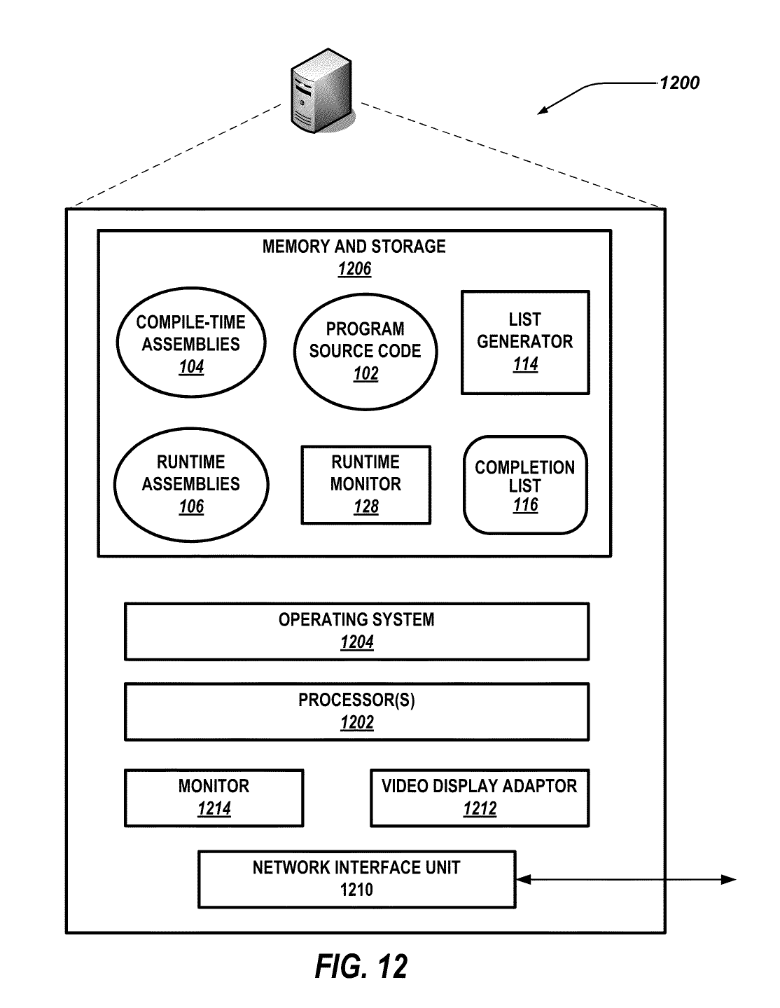

A computing device may be a special purpose or general purpose computing device. Example computing devices include mainframes, servers, blade servers, personal computers, portable computers, communication devices, consumer electronics, or the like. FIG. 12 illustrates an example embodiment of a computing device that may be used to implement system 100.

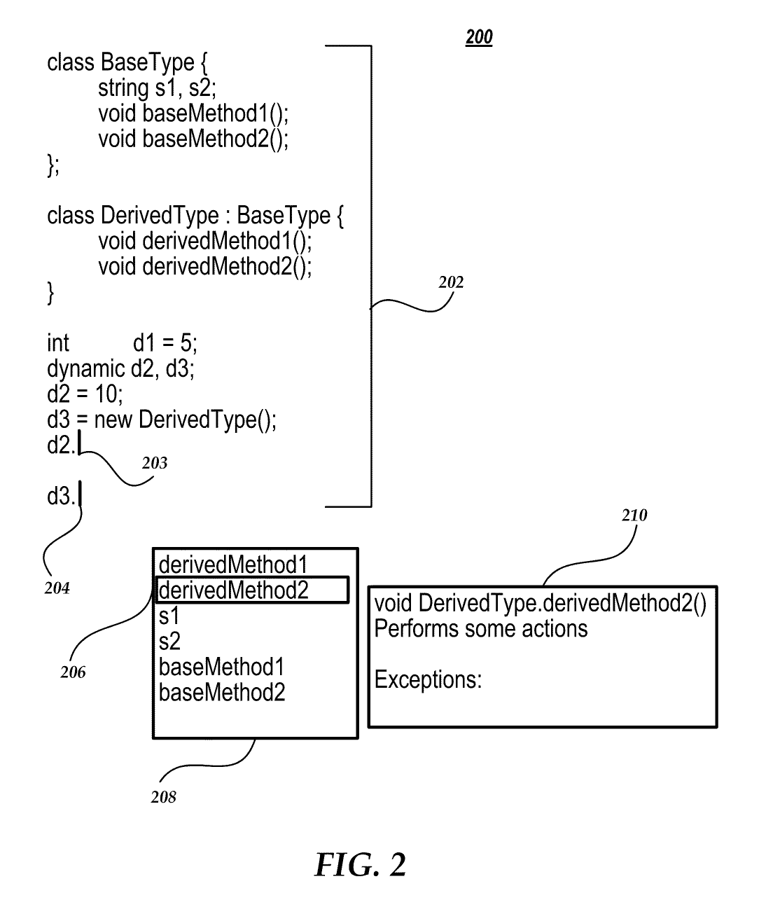

FIG. 2 illustrates a screen shot 200 of an editing session in which some mechanisms described herein may be employed. Screen shot 200 includes a view of source code snippet 202 that may be a portion of program source code 102 of FIG. 1. Source code snippet may be displayed by editor 110, though in some configurations a subset of source code snippet may be displayed. Some portions may be maintained in random access memory and not displayed, or may be maintained in one or more files. Source code snippet 202 is edited to illustrate certain lines of interest; various other lines of source code may be included, though not illustrated herein.

As shown in FIG. 2, source code snippet includes a class definition for class BaseType, and a class definition for class DerivedType, which is a subclass of BaseType. BaseType includes member variables s1 and s2, and member methods baseMethod1 and baseMethod2. DerivedType includes member methods derivedMethod1 and derivedMethod2.

Code snippet 202 includes declarations of variables d1, d2, and d3. Variable d1 is declared to be of type int in a static type declaration. Variables d2 and d3 are declared to be dynamic. In the C# programming language, a variable declared to be dynamic bypasses static type checking at compile time. Rather, the type of a dynamic variable is determined at runtime, based on the type of object that is assigned to it. For example, in this code snippet, variable d2 will receive an assignment of an int object (10); variable d3 will receive an assignment of a DerivedType object through a method call. The types of variable d2 and d3 are said to be resolved at runtime when the int object or DerivedType object are assigned to each of them, respectively.

In the example of FIG. 2, cursor 203 is located within code snippet 202 at a location following the string “d2.”; cursor 204 is located within code snippet 202 at a location following the text string “d3.”. As discussed herein, a cursor placed in a position following an identifier and a period may be a list invocation event and cause editor 110 to invoke completion list generator 114, which may receive source code 102 or portions thereof. List generator 114 may parse portions of the source code, and perform a control flow analysis to determine a type, or a candidate type, that an expression or variable may receive during target program execution, though the target program may not have been executed at the time. The expression is referred to herein as the “target expression.” A variable is a specific type of expression. When the target expression is a variable, the variable is referred to herein as the “target variable.” In the example code snippet 202, a control flow analysis performed in response to the event of cursor 203 may analyze the expressions and determine that the target variable d2 will receive a type int during execution, based on the assignment of an integer to it. A control flow analysis in response to the event of cursor 204 may analyze the expression “new DerivedType( )” and determine that it will evaluate to an object of type DerivedType. Therefore, the target variable d3 will resolve to type DerivedType during execution.

In some implementations, a compiler may translate source code to create one or more temporary variables for use when evaluating an expression at runtime. Some implementations may determine, during a static analysis, a temporary variable that may be created by a compiler, and perform a control flow analysis to determine a candidate object type of a temporary variable, and use this as part of an analysis of a corresponding target expression.

Though the variables d2 and d3 in example code snippet 202 are declared to be dynamic, in some embodiments the mechanisms described herein may be applied to variables for which a declaration does not exist or is unknown. For example, list generator 114 may not have information to indicate whether a variable is static or dynamic, and may apply at least some of the processes described herein in a way that is similar to that for an explicitly declared dynamic variable. This applies to other examples and discussions of dynamic variables herein.

Example screen shot 200 includes a view of a completion list 208 that may be displayed by editor 110 in response to a list invoking event and a completion list generation. Completion list generator 114 may generate completion list 208 or data corresponding to it. Editor 110 may receive the generated completion list and display it. In some embodiments, completion list generator 114 may generate a completion list in a first representation, and editor 110 may translate this into a second representation for display.

In the illustrated example of FIG. 2, completion list generator 114 may determine that, at the point of cursor 204, the target variable d3 will be an object of type DerivedType at execution time. As a result, completion list generator inserts members of the DerivedType class into the completion list. In the illustrated example, this includes derivedMethod1 and derivedMethod2, each of which is a method defined in the class DerivedType.

In one embodiment, upon determining a candidate type of an object, completion list generator may insert members that are available to the object in addition to those defined by the object's class. For example, members available to the object's parent class or any ancestor class may be included. In the illustrated example, members of the class BaseClass are inserted into the completion list. These are variables s1 and s2, and methods baseMethod1 and baseMethod2. In one embodiment, entries of a completion list are ordered so that the most specific class appear prior to those of a parent's or ancestor's members, though various embodiments may order them in a variety of ways.

In some embodiments, the entries of a completion list may be filtered based on characters that have been entered in the editor. For example, if the letter ‘b’ were entered after the period, members other than those beginning with the letter ‘b’ may be excluded from a resulting completion list.

It should be noted that, though the example code snippet 202 shows simple assignments to d2 and d3, in various programs, the assignment may be more complex and a more complex control flow analysis may be performed. For example, a variable may be part of a chain of assignments with intermediate variables, as in the following code snippet.

dynamic d3, d4, d5;
d3 = new DerivedType( );
d4 = d3;
d5 = d4;
d5.

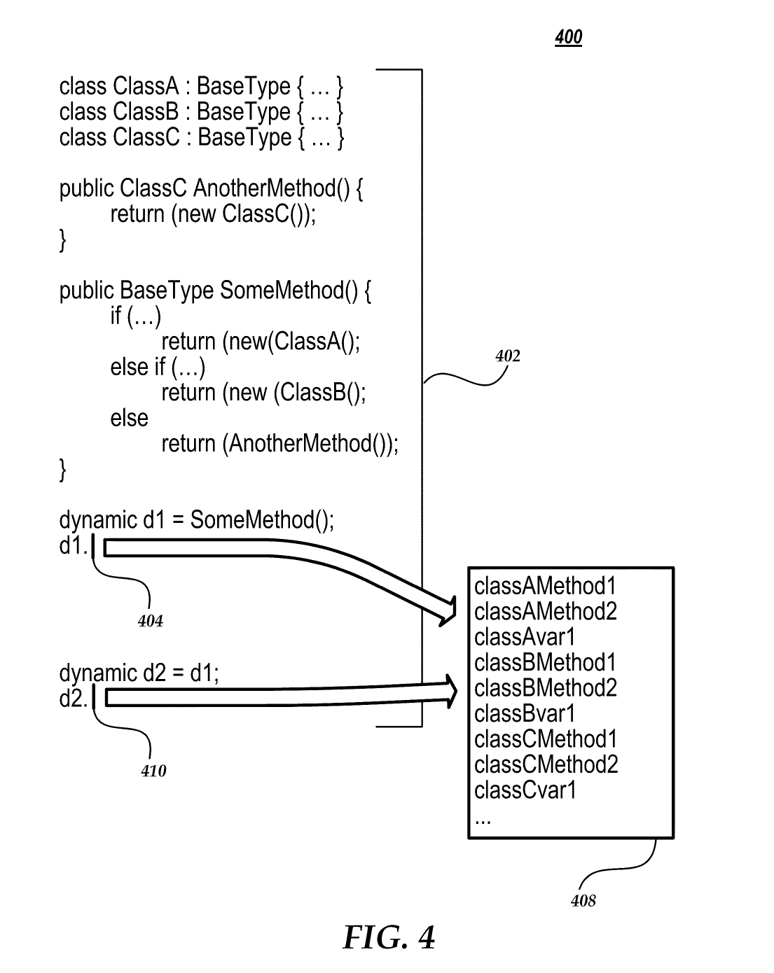

Thus, a control flow analysis by completion list generator may determine that d5 will be an object of type DerivedType during runtime, and generate a completion list for it accordingly. In another example, one or more levels of function calls may be included in a chain that results in an object type being assigned to a dynamic variable. An analysis may therefore follow a chain of function calls to determine an object type. In another example, a variable may be conditionally assigned to one of several object types. FIG. 4 illustrates one such example.

In one embodiment, a user may select an item from completion list 208. Box 206 represents a selected item, which may be highlighted or indicated in various ways. One embodiment may display information box 210, with information corresponding to the selected item. For example, information box 210 may display a declaration of a method, including specification of its parameters, text descriptive of the method, or a list of exceptions that may be caused by the method. Various implementations may display other types of information.

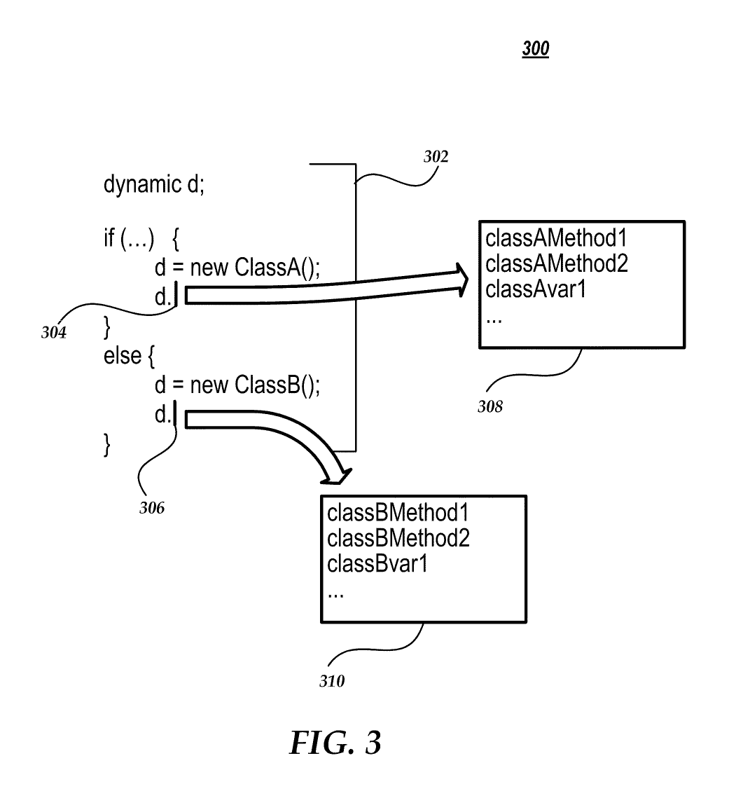

FIG. 3 illustrates a screen shot 300 of an example editing session in which some mechanisms described herein may be employed. In screen shot 300, source code snippet 302 includes two assignments to variable d, each in an alternative conditional clause. In the “if” clause, an object of type ClassA is assigned to d at runtime. In the “else” clause, an object of type ClassB is assigned to d at runtime. By performing a control flow analysis in response to a list invoking event of cursor 304 following “d.” in the “if” clause, completion list generator 114 may determine that at this point during runtime, d will be an object of type ClassA, and insert corresponding class members, such as displayed in completion list 308. Similarly, by performing a control flow analysis in response to an event of cursor 306 following “d.” in the “else” clause, completion list generator 114 may determine that at this point during runtime that d will be an object of type ClassB, and insert corresponding class members, such as displayed in completion list 310. Thus, in one embodiment, completion list generator includes logic to recognize that a determination of an object's class may be based on its location in the source code, and generate a completion list accordingly. Numerous other code configurations may exist in which completion list generator 114 may determine an object's type based on a control flow analysis and a current position within the source code. As discussed herein, in one embodiment, completion list generator 114 may include candidate types that are determined from instructions not reachable from the current position; members may be ordered in the completion list based on whether the associated instructions are reachable, based on a control flow analysis.

FIG. 4 illustrates another screen shot 400 of an example editing session in which some mechanisms described herein may be employed. In screen shot 400, source code snippet 402 includes declarations of ClassA, ClassB, and ClassC as types that are derived from BaseType. Source code snippet 402 includes a conditional control flow with three alternative return statements. The first two return statements return an object of type ClassA or ClassB, respectively. The third return statement returns an object of type ClassC, which can be determined by following the invocation of AnotherMethod( ) analyzing the code of Another Method( ), and observing that this returns an object of type ClassC. Thus, method SomeMethod( ) returns an object of one of three candidate types. The invocation of SomeMethod( ) and assignment to dynamic object d1 causes d1 to be an object of one of these three types at runtime.

In response to a list invoking event of cursor 404 following “d1.”, completion list generator 114 may perform a control flow analysis of SomeMethod( ) and AnotherMethod( ), determining the three candidate types for object d1. For each of these three types, completion list generator 114 may insert corresponding class members, so that the completion list includes members of all three classes. Completion list 408 illustrates an example of this. Though not illustrated, completion list 408 may include members of ancestor classes of each of classes ClassA, ClassB, and ClassC.

As illustrated by FIG. 4, a control flow analysis may extend many levels when following method invocations. The invocations may form a directed graph. In some embodiments, completion list generator 114 may be configured to limit the depth of the graph that is examined during a control flow analysis. In one embodiment, completion list generator 114 may be configured to limit its analysis in another manner, such as by a specified number of candidate classes inserted, an amount of execution time, or another factor.

It is to be noted that the examples of FIG. 3 and FIG. 4 differ in that, though each code snippet provides more than one candidate type for a dynamic object, at the location of each cursor 304 and 306, only one candidate type is determined. If a list invocation event occurred outside of the if-then-else statement, multiple classes may be possible, and a completion list would reflect this, as in the example of FIG. 4.

Code snippet 402 also illustrates transference of a candidate type set between variables. Variable d2 is declared to be dynamic, and variable d1 is assigned to it. In response to a list invoking event of cursor 410 following “d2.”, completion list generator 114 may determine that variable d2 may be any object that can be assigned to variable d1, and therefore the candidate types of variable d1 may be transferred to variable d2 during a control flow analysis. Thus, a control flow analysis with respect to variable d2 at the point of cursor 410 may perform a control flow analysis of variable d1 at that point, resulting in a completion list, such as completion list 408, having members that would be on a completion list of variable d1.

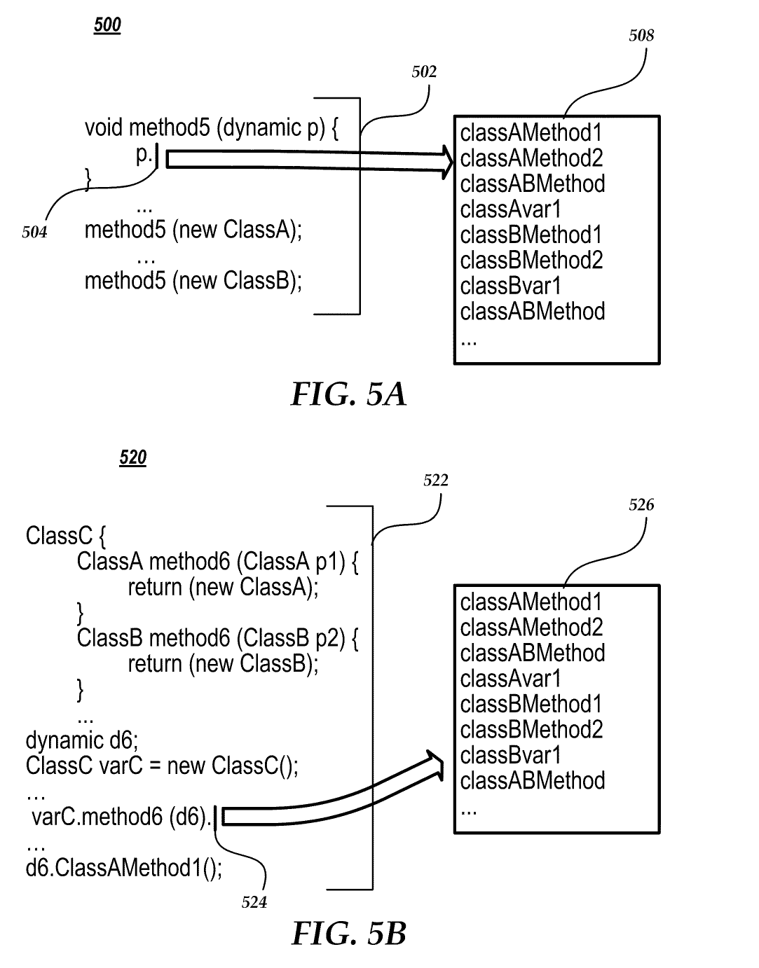

FIG. 5A illustrates a screen shot 500 of another example editing session in which some mechanisms described herein may be employed. In screen shot 500, source code snippet 502 includes a declaration of method5 having a dynamic parameter p. The declaration does not indicate a type for parameter p; the type of p will be resolved when it is invoked at runtime, and it may differ with each invocation. However, a control flow analysis in response to a list invoking event of cursor 504 following “p.” may be performed to find an invocation of method5. In the example, there are two such invocations. In one, an object of type ClassA is passed as an argument corresponding to the parameter p, and is therefore to be assigned to p. In the second invocation, an object of type ClassB is passed as an argument corresponding to the parameter p. It may be inferred that parameter p may become a variable of type ClassA or ClassB. Therefore, completion list generator 114 may add ClassA and ClassB to the candidate type set for variable p. Source code snippet 502 illustrates assignments of an expression to a variable, though they are done by the passing of arguments, rather than an assignment statement.

As discussed herein, completion list generator 114 may retrieve class member names for the candidate classes ClassA and ClassB. Completion list 508 shows an example completion list with ClassA methods ClassAMethod1, ClassAMethod2, and ClassABMethod, and ClassA variable ClassAvar1. The completion list also includes ClassB methods ClassBMethod1, ClassBMethod2, and ClassABMethod, and ClassB variable ClassBvar1.

The example completion list 508 includes two methods having a common name. In this example, ClassA includes a method named ClassABMethod; ClassB includes a method named ClassABMethod. This method name may be of particular interest to a programmer who may want to select a method that is common to both ClassA and ClassB. In one embodiment, members that are common to multiple candidate classes, or members that are associated with multiple source code instructions, may be ordered in a completion list before other members.

FIG. 5B illustrates a screen shot 520 of another example editing session in which some mechanisms described herein may be employed. In screen shot 520, source code snippet 522 includes two declarations of method6, in which one method6 (referred to as method6 (ClassA) has a parameter of type ClassA and returns an object of type ClassA, and one method6 (referred to as method6 (ClassB) has a parameter of type ClassB and returns an object of type ClassB. Thus, the methods are overloaded, and an invocation is determined by the argument that is passed to it. An invocation of method6 passes an argument that is declared to be dynamic. In response to a list invoking event of cursor 524 following the invocation of method6, a control flow analysis may be performed to determine available methods or members that are to be in a completion list. It is to be noted that in this example, the target expression is not a variable, but an expression that includes a method invocation.

In this example, a control flow analysis may determine that the dynamic variable d6 is used to invoke ClassAMethod, which is a method of ClassA. It may be inferred that the argument d6 passed in the invocation of method6 has a type of ClassA, and that therefore, method6 (ClassA) is invoked, returning an object of ClassA. Therefore, ClassA may be added to a candidate type set for a completion list corresponding to the target expression. As discussed herein, in some embodiments, an inference that method6 (ClassB) may also be invoked may be made, and ClassB may be added to the candidate type set. In some embodiments, the completion list may be ordered so that the members associated with ClassA are listed before the members of ClassB, based on the invocation of method6.

Though not illustrated in FIG. 5B, in some configurations, a determination of a completion list for a target expression other than a variable may employ one or more of other techniques discussed herein. For example, an analysis of the possible types of variable d6 when used in the target expression may employ any of the mechanisms described herein, including static analysis or dynamic analysis, as applied to a target variable. For example, though not illustrated in FIG. 5B, in some embodiments, a dynamic analysis may be performed to determine a completion list for the target expression of FIG. 5B. A runtime monitor may determine that the invocation of method6 in the target expression returns an object of type ClassA one or more times, and add this class to a candidate type set based on this observation.

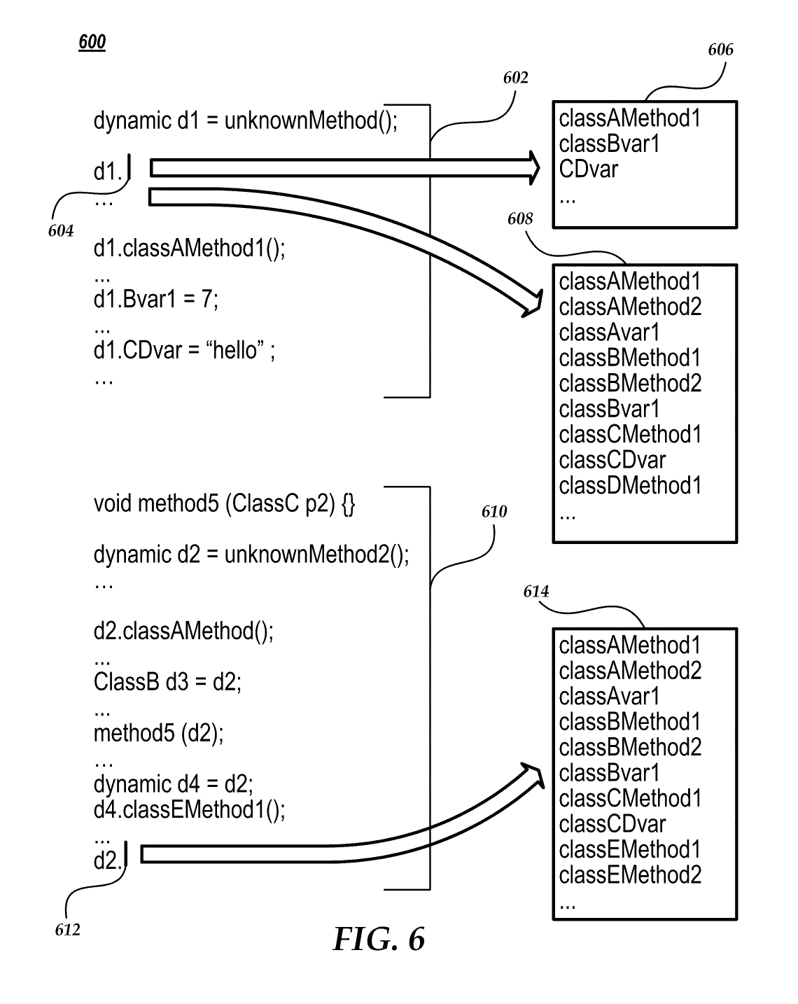

FIG. 6 illustrates a screen shot 600 of another example editing session in which some mechanisms described herein may be employed. In screen shot 600, source code snippet 602 includes a declaration of dynamic variable d1, and a cursor 604 following “d1.”. A control flow analysis in response to the cursor event may locate one or more statements that include a use of variable d1 at runtime. In the example code snippet, three such statements are illustrated.

d1.ClassAMethod1( );
d1.Bvar1 = 7;
d1.CDvar = “hello”;

The first statement invokes a method (ClassAMethod1) of the object bound to variable d1. The second statement references a member variable (Bvar1) of variable d1. The third statement references another member variable (CDvar) of variable d1. For this example, it is assumed that ClassAMethod1 is defined in the class ClassA, Bvar1 is defined in the class ClassB, and CDvar is defined in two classes: ClassC and ClassD.

In one embodiment, completion list generator 114 may retrieve each of these member names from the source code and add them to a completion list, as shown in completion list 606. Completion list generator 114 may look up each member in a database, such as database 112, to retrieve additional information for display in completion list 606 or in an information box.

In one embodiment, completion list generator 114 may retrieve each of these member names from the source code and, for each name, determine one or more classes that define these names. In this example, it may determine that the classes ClassA, ClassB, ClassC, and ClassD define the three member names. Each of these classes may be added to a candidate type set, and the members of each class may be inserted into a completion list. Completion list 608 illustrates an example of such a completion list, having the aggregate member list of these four classes, including members that are not referenced in the source code.

Though the techniques associated with completion list 606 and completion list 608 may be associated with alternative embodiments, some embodiments may combine these techniques, or portions thereof. For example, in one embodiment, class members may be grouped into multiple completion lists. In one embodiment, class members may be ordered based on a mechanism from which each was determined. These embodiments are discussed in further detail herein.

Code snippet 610 illustrates other uses of a target variable. In this example, code snippet 610 includes a dynamic variable d2, which is assigned an object from an unknown method, or a method from which the return type is not known. A control flow analysis in response to a list invoking event of cursor 612, following the text “d2.” may locate the following example statements in which variable d2 is used.

d2.ClassAMethod1( );
ClassB d3 = d2;
method5 (d2);
dynamic d4 = d2;

The first statement references a member of ClassA. As described above, completion list generator 114 may add ClassA to the candidate type set based on this reference. The second statement uses variable d2 in an expression, assigning the object bound to d2 to the variable d3, which is statically declared to have a type ClassB. In one embodiment, completion list generator 114 may infer that an expression may be of the same type as the variable to which it is being assigned, and that a dynamic variable used as an expression may be the same type. Therefore, ClassB may be added to the candidate type set.

The invocation of method5 uses variable d2 as an argument that is assigned to the parameter p2 in method5. This is similar to the assignment to d3, but it is an assignment through a method invocation, rather than an assignment statement. The parameter p2 is declared to have a type of ClassC. Therefore, it may be inferred that the variable d2 may have a type of ClassC. This class may therefore be added to the candidate type set.

In the fourth example use, variable d2 is used as an expression assigned to another dynamic variable, d4. In determining type inferences for variable d2, completion list generator 114 may recursively determine candidate types for variable d4 at the location of the assignment. This may lead to the use of d4 in the statement d4.ClassEMethod1( ). As discussed herein, this reference to a method of ClassE may allow an inference that ClassE is a candidate type for d4. Therefore, ClassE becomes a candidate type for variable d2. Thus, the mechanisms described herein may be chained together, or recursively applied, to determine candidate types for a target expression.

In the illustrated example, completion list generator may therefore insert members of ClassA, ClassB, ClassC, and ClassE into a completion list, such as displayed in completion list 614.

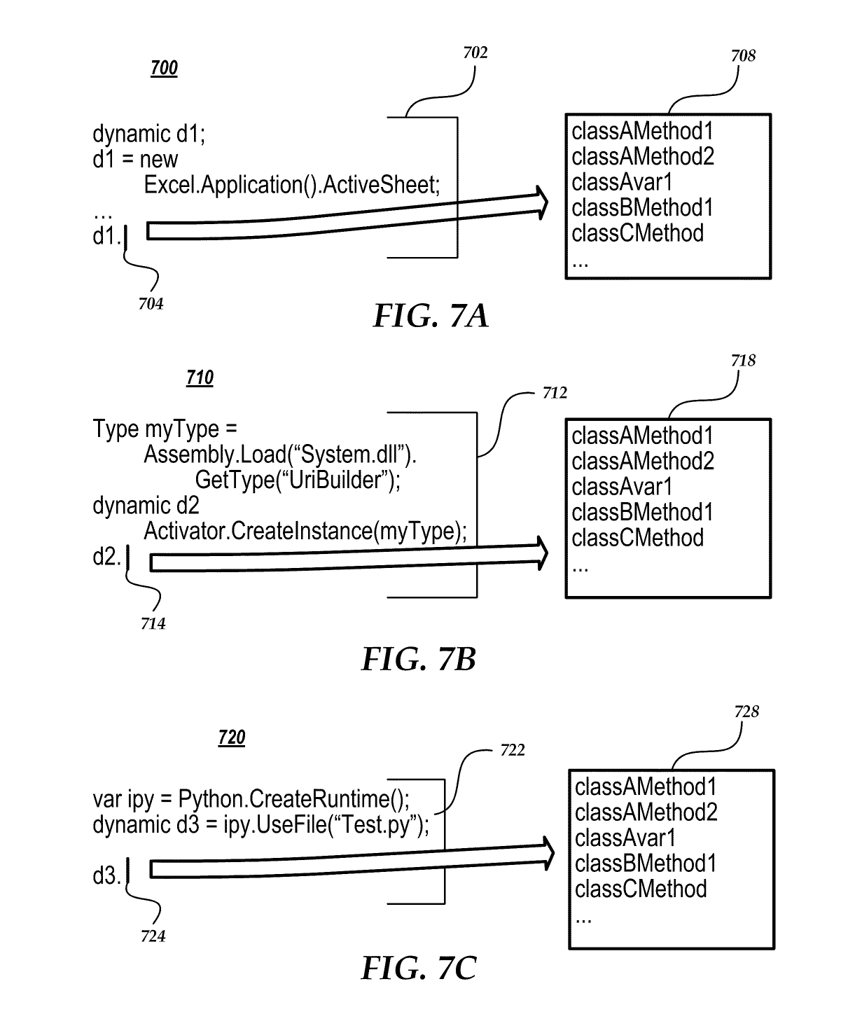

FIGS. 7A-C illustrate additional screen shots 700, 710, and 720, respectively, of example editing sessions in which some mechanisms described herein may be employed. These screen shots provide examples of configurations in which hints for determining candidate object types reside in assemblies other than the primary assembly of the source code.

In screen shot 700, source code snippet 702 includes an assignment in which a worksheet object is created from a Microsoft.Office.Interop.Excell.dll interop assembly. This is considered a compile-time assembly 104. In one configuration, objects returned from this COM API may be treated as dynamic. In response to a list invocation event with cursor 704 at the illustrated location, completion list generator 114 may determine, based on the invocation of this assembly, that variable d1 will become an object type defined in the specified interop assembly. It may obtain a list of such types, and insert the members of these types into a completion list, such as illustrated by completion list 708.

In screen shot 710, source code snippet 712 includes an assignment in which dynamic variable d2 is initialized using an external assembly that is to be loaded at runtime. In response to a list invocation event with cursor 714 at the illustrated location, completion list generator 114 may retrieve the string that is passed to the Load( ) call (“System.dll” in this example), load the assembly while in an editing session, and determine candidate types and members based on the assembly. The actions may further include determining a candidate type based on the string passed to the GetType( ) call (“UnBuilder” in this example). In one implementation, an object of the candidate type thus determined may be instantiated while in an editing session. Reflection may be used to obtain a list of members of the specified type. Members obtained in this way may be inserted into a completion list, such as illustrated by completion list 718. In some embodiments, upon loading an assembly as described above, additional mechanisms described herein, such as performing a control flow analysis within the loaded assembly, may be used to determine candidate types of an object returned from the assembly. Thus, though the assembly is considered a runtime assembly, these mechanisms may load the assembly during an editing session.

In screen shot 720, source code snippet 722 includes an assignment in which dynamic variable d3 is initialized using a script file for a dynamic language that is to be loaded at runtime. In response to a list invocation event with cursor 724 at the illustrated location, completion list generator 114 may load this script file during an editing session, and determine candidate types and members based on this. Members obtained in this way may be inserted into a completion list, such as illustrated by completion list 728.

In one implementation, in order to limit the quantity of types or the quantity of items in the completion list for each of the mechanisms illustrated by FIGS. 7A-C, completion list generator 114 may delay inserting items from the specified assembly or script file until at least a first character is entered following the list invocation event. Items may then be filtered to exclude those that do not begin with the entered character(s). In one implementation, items from the specified assembly or script file may be filtered by using other techniques described herein, such as analyzing members referenced from the variable d1, d2, or d3 used in other statements of the source code, or other ways in which variable is used.

Additionally, each of the mechanisms illustrated by FIGS. 7A-C may be used as a result of a control flow analysis as described herein, and results of different mechanisms may be combined when inserting items into a completion list. A simple example may be a series of conditional statements that assign an object to a dynamic variable d, where any of the conditional assignments may include retrieval from a compile-time assembly, a runtime assembly, a script file, or source code of the edited file. Thus, types or members retrieved from each of these conditional assignments may be combined to generate a completion list.

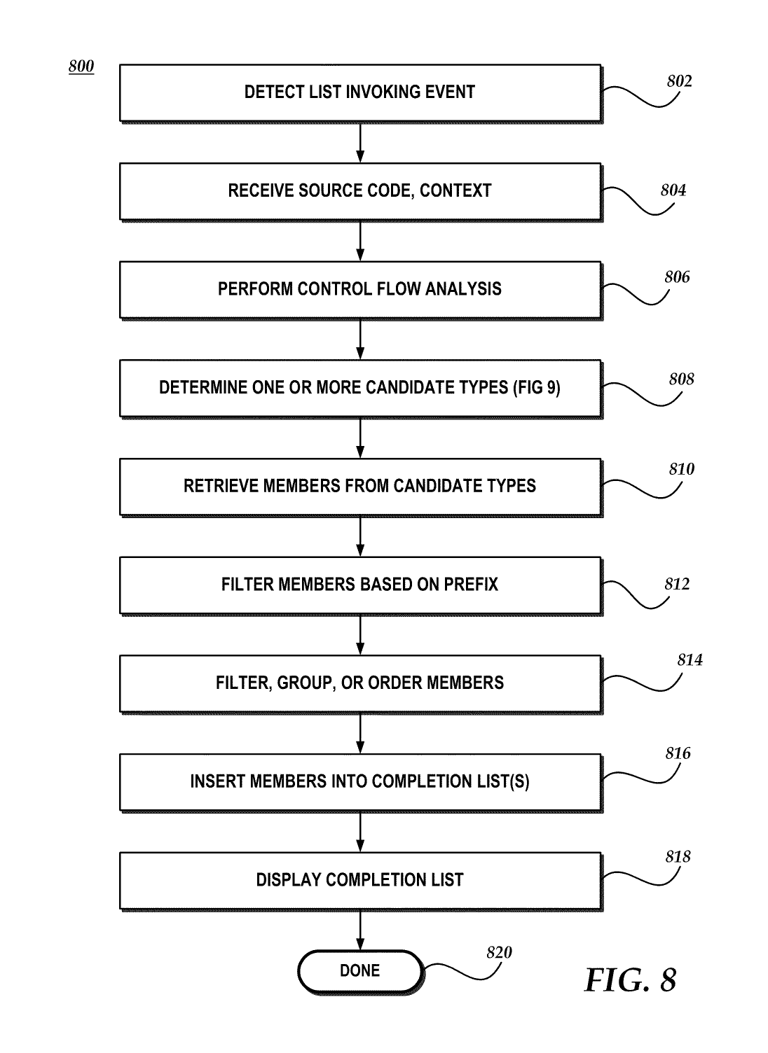

FIG. 8 is a flow diagram illustrating an example embodiment of a process 800 of providing a completion list to a user. In one embodiment, some of the actions of process 800 are performed by components of computer system 100 of FIG. 1.

The illustrated portions of process 800 may be initiated at block 802, where a list invoking event may be detected. In one embodiment, editor 110 may detect a list invoking event and invoke list generator 114.

The process may flow to block 804, where the current editing context and at least a portion of the program source code are received. The context may include the location of an editing cursor, a text string preceding the cursor, a location in a source code file, a source code file name, or other such information. Specification of an identifier that represents a program variable may be included as part of the context, or derived therefrom. The variable for which a corresponding completion list is generated is referred to as the “current” variable herein. Though block 804 is illustrated as a single block, these actions may be distributed across actions of process 800. For example, portions of source code may be received as requested during the process.

Process 800 may flow to block 806, where a control flow analysis may be performed. As discussed herein, these actions may include parsing various portions of the source code, determining a directed graph of a program flow or variable initialization, or other aspects of a program analysis.

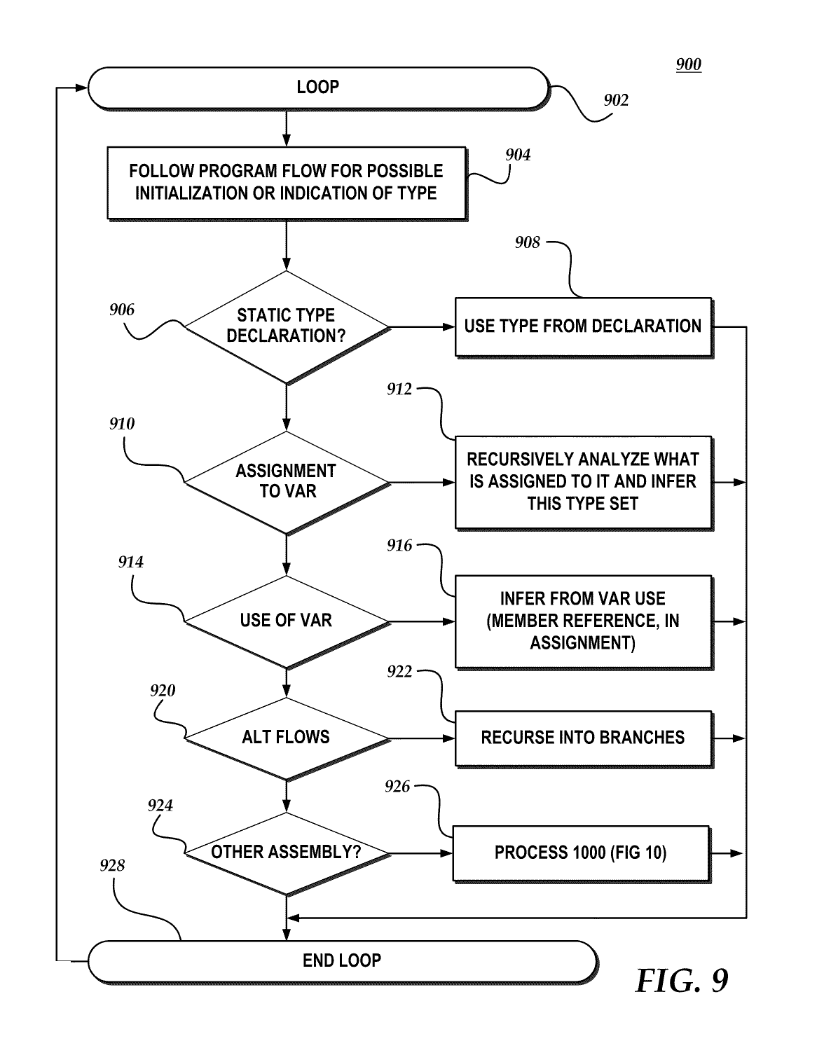

The process may flow to block 808, where one or more candidate types of the current variable may be determined. This may be based on assignments, member references, uses, declarations, or other program components relating to the current variable or other variables that may directly or indirectly relate to the current variable. FIG. 9 illustrates in further detail, example actions of block 808. The actions of block 808 may result in a set of one or more candidate variable or object types for the current variable in the current context. This set is referred to as the candidate type set.

The process may flow to block 810, where names of members associated with the candidate type set may be retrieved. For example, if a type is a class, members may include variables or methods that are defined for the class and are available to be referenced by the current variable. The actions of block 810 may include generating a completion list that includes the union of members associated with the types of the candidate type set.

The process may flow to block 812, where the members of the completion list may be filtered based on a prefix at the location of the cursor. The members may be filtered to exclude those that do not match the prefix. For example, if a string before a cursor is “d.na”, the completion list may be filtered to exclude member names that do not begin with the substring “na”. In some implementations, filtering may be integrated with the actions of block 810.

The process may flow to block 814, where the members may filtered based on configured criteria, formed into one or more groups, or ordered based on configured criteria. In some embodiments, a completion list generator may create multiple candidate type sets or multiple completion lists in response to an invocation. The multiple lists may be grouped in a variety of ways. In one embodiment, lists may be grouped based on a technique for generating the items in each list. For example, completion lists 606 and 608 of FIG. 6 illustrate two techniques for generating a completion list. One embodiment may generate both of these completion lists. A user interface may provide mechanisms for a user to select and view one of the lists, view both lists at the same time, or merge both lists. A user interface, for example, may present a tabbed window, in which each tab corresponds to a different completion list. In another example, one completion list may include members of classes that were directly inferred to be candidate types, as discussed herein. Another completion list may include members belonging to parent or ancestor classes of each of the classes corresponding to the first completion list. In another example, a first completion list may present members corresponding to candidate types found in a current assembly, and one or more other completion lists may correspond to candidate types found in other assemblies.

In one implementation, members of the completion list may be filtered to restrict identifiers that are duplicates. This may occur, for example, if multiple classes define methods having a common name. Thus, in one implementation, a completion list may include identifiers that are unique within the completion list. Completion list 508 of FIG. 5A illustrates an embodiment in which duplicate member names (classABMethod) are included. However, in one embodiment, the duplicate member name, classABMethod, may be filtered out.

Multiple completion lists may be implemented in a variety of ways. For example, in one implementation, a single completion list may be maintained, and a filter applied to it each time a request for a specified grouping is received. In one implementation, multiple structures may maintain multiple lists, which may be combined when a request for a complete list is received.

In one embodiment, items in completion lists may be ordered based on one or more configured factors. An alphabetical listing is one such example. Some other example factors include criteria for selecting groups, as discussed above. Thus, items associated with a current assembly may be prioritized higher than items associated with system or external assemblies. Members explicitly referenced, such as shown in completion list 606, may have a higher priority than members of classes corresponding to the referenced members, as shown in completion list 608. In one embodiment, inferences of candidate types that are made from instructions reachable in the same control flow as the location of the target expression may be ordered before inferences made from instructions that are not reachable. For example, in FIG. 3, completion list 310, corresponding to cursor 306, may include members of ClassA even though the assignment of a ClassA object is not reachable from cursor 306. One embodiment may prioritize the members of ClassB, and order these below the members of ClassA in a completion list at this location.

A class member or a class may be prioritized based on the number of times it is associated with a use of a target expression. In one embodiment, a system may track data descriptive of a number of times a list item is selected by the user, and prioritize list items based on this history. Data maintained by a monitor during one or more prior runtimes may be used to order classes or class members based on usage frequency, runtime control flows, or other historical data.

The process may flow to block 816, where the members may be inserted into one or more completion lists, as discussed herein.

The process may flow to block 818, where one or more generated completion lists, or a portion thereof, may be displayed. FIGS. 2-7 illustrate representations of displayed completion lists. The process may flow to done block 820 and exit or return to a calling program.

In one configuration, the actions of blocks 802 and 818 may be performed by editor 110, and the actions of blocks 804-816 may be performed by list generator 114. However, in various implementations, the actions of process 800 may be distributed differently among editor 110, list generator 114, or other components of system 100, including those that may not be illustrated in FIG. 1.

Though the actions of process 800 are presented in discrete blocks, in various implementations they may be combined in various orders or intermixed in a variety of ways, including actions that are performed concurrently by one or more threads. Thus, FIG. 8 provides a description of an example embodiment, but implementations may vary.

FIG. 9 is a flow diagram illustrating an example embodiment of a process 900 of determining one or more candidate types of a program expression. Process 900 may be used to implement at least some actions of block 808 of process 800. Process 900 may be initiated at loop 902, which iterates for possible indications of a variable type. In the illustrated embodiment, loop 902 includes blocks 904-920 and is terminated at block 928.

At block 904, using a control flow analysis, the target program flow may be followed to find possible initializations of the current variable, or other indications of the variable type. This may including traversing the target program in a forward or reverse direction, following method invocations, following alternative flow branches, or other techniques of flow control analysis. Though this is shown as a single block, the actions of block 904 may be performed together with actions of any other block of process 900.

The process may determine a configuration that is reached during a control flow analysis. Though FIG. 9 illustrates a number of decision blocks corresponding to possible configurations, implementations may vary as to how the process determines actions to take based on source program configurations.

At decision block 906, a determination may be made of whether a static type declaration for the current variable is found. An example of a static type declaration is
int v1=5;

This statement both declares variable v1 to be an integer type and initializes it to a value of 5. If, at decision block 906, the determination is positive, the process may flow to block 908, where the specified type from the declaration may be inserted in a candidate type set. In one embodiment, the type of the parent class and other ancestor classes may be inserted in the candidate type set. The process may flow to block 928, which terminates loop 902. It may loop back to loop 902 or exit the loop, based on source program configuration, current context, or process implementation. In some implementations, loop 902 may continue while there are program portions that are relevant to determining a type and that have not been analyzed by process 900. In some implementations, one or more specified limits may cause loop 902 to exit. For example, a limit on a number of types in a candidate type set, a limit on the amount of code that is analyzed, a limit on a number of members corresponding to the candidate type set, an execution time limit, or another specified limit may cause loop 902 to exit. After the last iteration of loop 902, the process may return to a calling program, such as process 800.

In one embodiment, a determination that a variable does not have a static type declaration implies that the variable is a dynamic type. Therefore, in this embodiment, the actions of blocks 910-920 are applied to dynamic types. In one embodiment, the actions of blocks 910-920 may be applied to a static type, for example to determine candidate subclasses of a declared type. In some configurations, a variable without a static type declaration may not have a declaration of dynamic type. This may occur, for example, in an environment in which the source code is incomplete. In one embodiment, a variable without a type declaration is processed in a manner similar to that for variables declared to be dynamic. The process for such variables may flow from decision block 906 to decision block 910.

If, at decision block 906, the determination is negative, the process may flow to decision block 910, where a determination is made of whether an assignment to the current variable is found. As discussed herein, this may occur in the context of an assignment statement, an argument passed to be assigned to a function parameter, or another program construct.

If, at decision block 910, it is determined that an assignment to the current variable is found, the process may flow to block 912, where the process may recursively analyze the expression to determine one or more types that are to be assigned to it, and infer that these are candidate types. Depending on what is assigned, this may include additional control flow, such as following a method invocation, or determining one or more candidate types for another variable. Code snippets 202, 302, 402, 502 of FIGS. 2-5, respectively include examples of assignments and expressions. The process may flow to block 928, and continue as described above.

If, at decision block 910, it is determined that an assignment to the current variable is not found, the process may flow to decision block 914, where a determination is made of whether a use of the current variable is found. Code snippet 402 provides four example uses of variable d. These include invoking a member method, referencing a member variable, assigning the variable to another variable in an assignment statement, and assigning the variable to a parameter by passing the variable as an argument to a method. If the determination of decision block 914 is positive, the process may flow to block 916, where one or more types may be inferred from the variable usage. Assignment of the target expression to another variable allows an inference that the type of the other variable is a candidate type for the target expression. This may be in the form of an assignment statement, an argument passed in a function invocation, or other type of assignment. As illustrated by the example assignment of d2 to d4 in code snippet 610 of FIG. 6, analyzing a target expression or variable that is assigned to a second variable may include recursively analyzing candidate types of the second variable, using mechanisms described herein.

Member references of a target expression allow an inference that a type that exposes the member, explicitly or through inheritance, is a candidate type of the target expression. In some cases, this may include multiple types. The process may flow to block 928, and continue as described above.

If, at decision block 914, the determination is negative, the process may flow to block 920, where a determination may be made of whether the program flow leads to multiple alternative control flows. Code snippet 502 of FIG. 5A provides an example of conditional alternative control flows. If the determination at decision block 920 is positive, the process may flow to block 922, where process 900, or a portion thereof, may be performed recursively for each alternative branch of the control flow. In example code snippet 502, three recursive processes may be initiated. Though these actions are described herein in terms of recursion, it is understood that this is a conceptual description, and various implementations may use techniques other than recursion to perform process 900, or a portion thereof, for each branch of the flow.

As a result of recursively processing each of the branches, zero, one, or more candidate types from each branch may be added to the candidate type set, and associated members may be added to the completion list. The process may flow to block 928, and continue as described above.

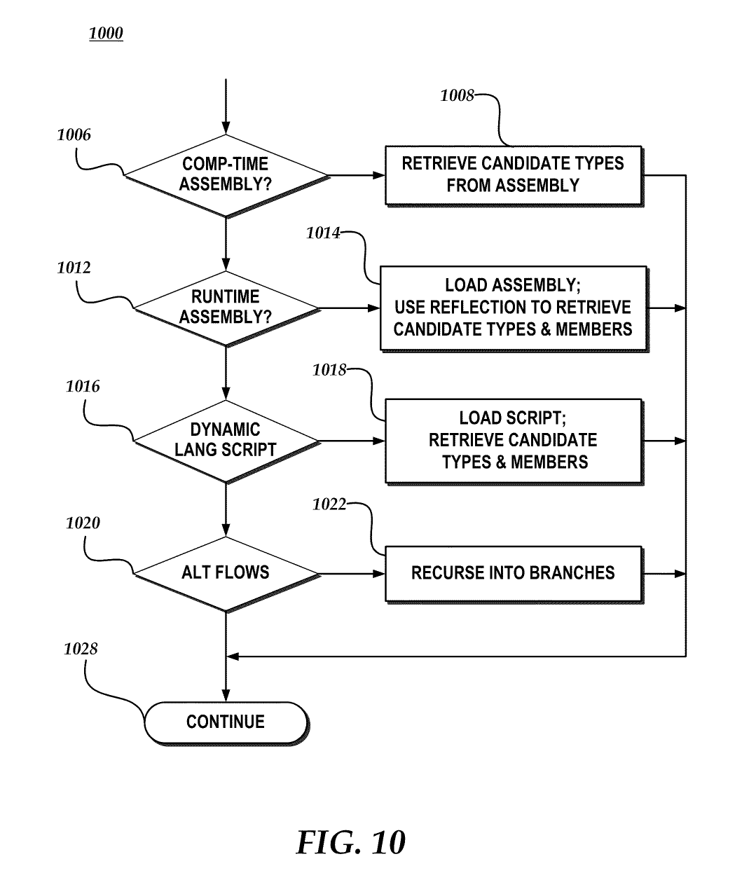

If, at decision block 920, the determination is negative, the process may flow to block 924, where a determination may be made of whether the program flow leads to another assembly or script. If this determination is positive, the process may flow to block 920, where an additional assembly or program script may be analyzed. Process 1000 of FIG. 10 illustrates an example embodiment of such actions. The process may flow to block 928 and continue as described herein.

If, at decision block 924, the determination is negative, the process may flow to block 928 and continue as described herein.

FIG. 10 is a flow diagram illustrating an example embodiment of a process 1000 of determining one or more candidate types of a program variable, based on program code. Process 1000 may implement the actions of block 926, or a portion thereof. The actions of process 1000 may be performed in a variety of orders and in a variety of ways, though the current one is used for illustration.

Process 1000 may begin at decision block 1006, where a determination is made of whether the program flow leads to program code in a compile-time assembly. If such a determination is positive, the process may flow to block 1008, where candidate types may be retrieved from the specified assembly. In one implementation, this may include retrieving a complete set of types of the assembly that are available to program code outside of the assembly. In one implementation, this may include retrieving one or more candidate types based on an invocation of a method in the assembly or a reference to a class in the assembly. In one embodiment, the actions of block 1008 may include recursively performing at least a portion of process 900 within the assembly. The process may flow from block 1008 to block 1028 and continue by exiting or returning to a calling process, such as process 900.

If, at decision block 1006, the determination is negative, the process may flow to decision block 1012, where a determination may be made of whether the program flow leads to program code in a runtime assembly. In some environments, a runtime assembly may be specified by an instruction to load the assembly using a specified file name. As illustrated in FIG. 7B, an example source code statement that does this is:

Type myType=Assembly.Load(“System.dll”).GetType(“UriBuilder”);

In one embodiment, the actions of block 1014 may include loading the assembly specified in the Load( ) call during the editing session. Thus it is not necessary to wait until target program runtime to load the assembly and retrieve candidate types. The actions of block 1014 may include creating an instance of each of one or more classes defined in the assembly, and using reflection to determine available members. In the above example, an object of type “UriBuilder” may be created. The process may flow to block 1028, and continue as described above.

If, at decision block 1012, the determination is negative, the process may flow to decision block 1016, where a determination may be made of whether the program flow leads to program code in a dynamic language script. In some environments, a program instruction may specify the loading of a dynamic language script, which may be executed as part of the program execution. If such a determination is positive, the process may flow to block 1018, where a specified script is loaded. FIG. 7C illustrates example source code instructions that do this.

In one embodiment, the actions of block 1018 may include loading the script specified in the instruction to load the script, and searching the specified assembly, as well as additional assemblies within scope of the solution, to retrieve a candidate type set and members. The process may flow to block 1028, and continue as described above.

If, at decision block 1016, the determination is negative, the process may flow to block 1028, and continue as described above.

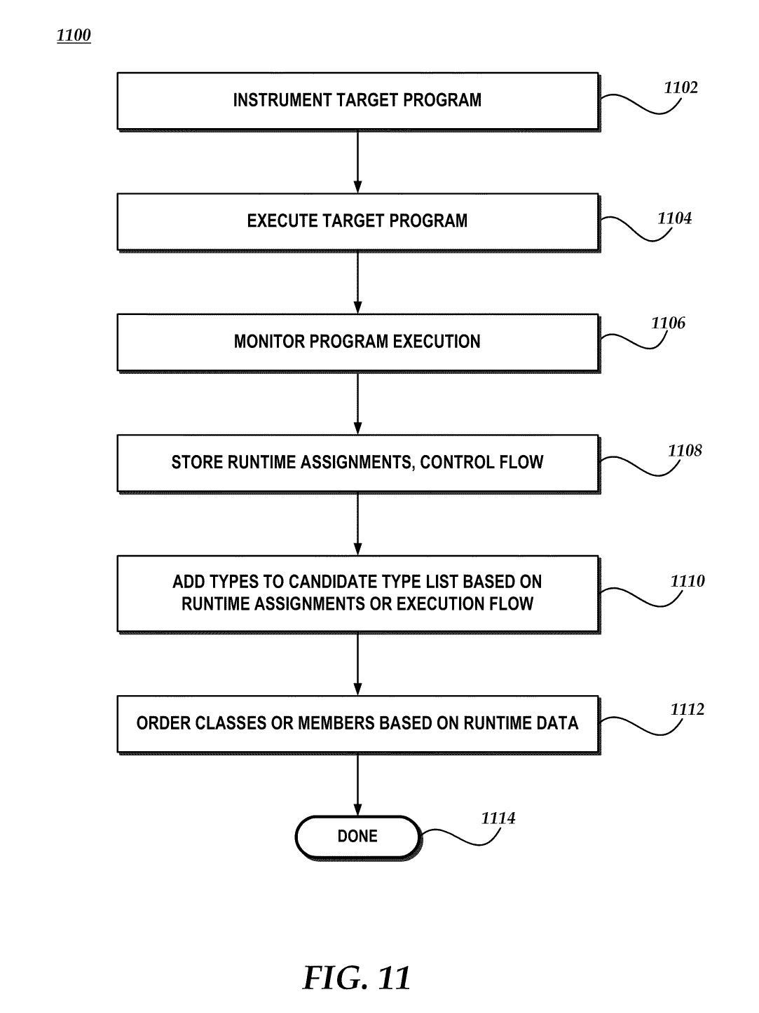

FIG. 11 is a flow diagram illustrating an example embodiment of a process 1100 of determining one or more candidate types of a program variable, based on a dynamic analysis of a target computer program. Process 1100 may be performed by components of computer system 100.

Process 1100 may begin at block 1102, where the target program may be instrumented to facilitate monitoring the program during runtime. Instrumentation may include inserting program instructions at certain places to cause events that are monitored by a program monitor, such as runtime monitor 128 of FIG. 1. In one embodiment, instrumenting the target program may be based on identification of dynamic program variables. One such example may be to cause an event after each assignment to a dynamic program variable. Events may also indicate branches that are taken or functions that are called during program execution. Though instrumentation of the target program may be employed with some techniques of runtime monitoring, some techniques do not use instrumentation. Thus, the actions of 1102 may be omitted in some implementations, or other mechanisms for setting up runtime monitoring may be used.

The process may flow to block 1104, where the runtime program is at least partially executed. At block 1106, the program execution is monitored to detect events such as assignments, execution paths taken, functions invoked, or the like. Monitoring the program execution may include detecting an object that is assigned to a target program variable through an assignment statement, by passing an object in a function invocation to be assigned to a function parameter, or by another type of assignment. These runtime type resolutions provide a runtime monitor with a specific object that is bound to a program variable. In some embodiments, a runtime monitor may examine the state or contents of a runtime stack. For example, the type or value of a data object on a runtime stack may indicate a class of an object or an expression. In some configurations, a data object on a runtime stack may correspond to a temporary variable representing an expression being evaluated at runtime.

Runtime monitor 128 may identify a class of the assigned object. In one embodiment, instrumented instructions or helper functions invoked from instrumented instructions may perform actions to identify an object's class. In one embodiment, runtime monitor 128 may operate in conjunction with a debugger to identify objects and their classes. For example, a debugger may insert one or more tracepoints and record information at each tracepoint.

Runtime monitor 128 may use reflection to determine an object's class or class members. In one embodiment, reflection may be used to determine class information corresponding to objects that are received from runtime assemblies. An object may implement an interface that enables a runtime monitor to query the data object. A query may provide the object's type or other information that facilitates determining the object's type. In one embodiment, reflection may be used in response to detection of an event such as invoking or entering a function, exiting a function, assignment to a program variable, execution of a conditional instruction, or reaching a breakpoint.

The process may flow to block 1108. At block 1108, the data retrieved during monitoring may be stored, such as in runtime database 130. The actions of blocks 1104 may occur one or more times. More specifically, the target program may be executed multiple times. For each execution, one or more assignments or execution flows may be detected and stored.

The process may flow to block 1110, where data may be retrieved from runtime database 130, and one or more types may be added to a candidate type list based on the runtime assignments or execution flows. The actions of block 1110 may be performed by completion list generator 114 and occur during an editing session after the target program execution.

In one embodiment, the process may flow to block 1112, where candidate types or class members are ordered based on the runtime data retrieved during a dynamic analysis. As discussed herein, this may be based on frequency of assignments. Classes that are associated with runtime bindings may be ordered before other classes that are determined by other mechanisms, such as static analysis. In some embodiments, members resulting from performing process 1100 may be grouped together and displayed apart from members determined by the use of source code analysis. In some embodiment, ordering of members may be based on a combination of dynamic analysis and a control flow analysis of the target program. For example, members determined by a dynamic analysis may be given a higher priority and ordered before members determined by dynamic analysis.

The process may flow to done block 1114 and exit, or return to a calling program. Process 1100, or portions thereof, may be combined or integrated with other mechanisms described herein, such as processes 800, 900, or 1000.

FIG. 12 shows one embodiment of a computing device 1200, illustrating selected components of a computing device that may be used to implement system 100 or perform functions described herein, including processes 800, 900, 1000, or 1100. Computing device 1200 may include many more components than those shown, or may include less than all of those illustrated. Computing device 1200 may be a standalone computing device or part of an integrated system, such as a blade in a chassis with one or more blades.

As illustrated, computing device 1200 includes one or more processors 1202, which perform actions to execute instructions of various computer programs. In one configuration, each processor 1202 may include one or more central processing units, one or more processor cores, one or more ASICs, cache memory, or other hardware processing components and related program logic. As illustrated, computing device 1200 includes an operating system 1204. Operating system 1204 may be a general purpose or special purpose operating system. The Windows® family of operating systems, by Microsoft Corporation, of Redmond, Wash., are examples of operating systems that may execute on computing device 1200.

Memory and storage 1206 may include one or more of a variety of types of non-transitory computer storage media, including volatile or non-volatile memory, RAM, ROM, solid-state memory, disk drives, optical storage, or any other medium that can be used to store digital information.

Memory and storage 1206 may store one or more components described herein or other components. In one embodiment, memory and storage 1206 stores the software components of system 100, or a portion thereof. The illustrated example components are compile-time assemblies 104, runtime assemblies 106, program source code 102, list generator 114, runtime monitor 128, and completion list 116, though more or less components may be stored in memory and storage 1206. Any one or more of these components may be moved to different locations in RAM, non-volatile memory, or between RAM and non-volatile memory by operating system 1204 or other components.

Computing device 1200 may include a video display adapter 1212 that facilitates display of program code or other information to a user. Though not illustrated in FIG. 12, computing device 1200 may include a basic input/output system (BIOS), and associated components. Computing device 1200 may also include a network interface unit 1210 for communicating with a network. Software components of system 100 may be received via transitory media and network interface unit 1210. Embodiments of computing device 1200 may include one or more of a display monitor 1214, keyboard, pointing device, audio component, microphone, voice recognition component, or other input/output mechanisms.

It will be understood that each block of the flowchart illustration of FIGS. 8-10, and combinations of blocks in the flowchart illustration, can be implemented by software instructions. These program instructions may be provided to a processor to produce a machine, such that the instructions, which execute on the processor, create means for implementing the actions specified in the flowchart block or blocks. The software instructions may be executed by a processor to provide steps for implementing the actions specified in the flowchart block or blocks. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A computer-based method of generating a completion list corresponding to a target program variable in a target program source code, comprising:
a) performing a control flow analysis to locate one or more source code instructions that each represent a runtime assignment of an object to the target program variable;
b) analyzing each of the one or more source code instructions to determine at least one candidate type corresponding to the target program variable;
c) for each candidate type, determining a set of class members associated with the type; and
d) aggregating the one or more sets of class members.

2. The computer-based method of claim 1, the one or more source code instructions including at least one instruction representing a runtime assignment of an expression to the target variable, determining at least one candidate type comprising analyzing the expression to determine at least one type corresponding to the expression.

3. The computer-based method of claim 1, the one or more source code instructions including at least one instruction representing a use of the target variable, determining at least one candidate type comprising analyzing the use of the target variable to determine at least one corresponding type.

4. The computer-based method of claim 1, the target variable is a program function parameter of a program function, the one or more source code instructions including an invocation of the program function, the invocation including an argument corresponding to the program function parameter, determining at least one candidate type is based on an object type of the argument.

5. The computer-based method of claim 1, the one or more source code instructions including at least two source code instructions that each represent a corresponding runtime assignment of an object to the target program variable, each object having a different corresponding object type from the other, the at least one candidate type comprising at least two candidate types, aggregating the one or more sets of class members comprising aggregating at least one class member corresponding to each candidate type.

6. The computer-based method of claim 1, further comprising retrieving, from a system assembly, at least one assembly candidate type and a corresponding set of assembly class members, and including the set of assembly class members with the aggregated set of class members.

7. The computer-based method of claim 1, further comprising, in an editing session:
a) determining whether the target program source code includes an instruction to load an assembly during runtime;
b) loading the assembly;
c) creating an instance of a class from the assembly;
d) employing reflection to retrieve members of the class from the assembly; and
e) including the retrieved members with the aggregated set of class members.

8. The computer-based method of claim 1, the source code including a declaration of the target variable as a dynamic type.

9. The computer-based method of claim 1, further comprising:
a) analyzing program instructions from each of two alternative program flows, including a first program flow and a second program flow; and
b) determining a set of candidate types from each of the two alternative program flows, the set of candidate types from the first program flow including at least one candidate type that is not in the set of candidate types from the second program flow.

10. A computer-based system for generating a completion list corresponding to a target program variable in a target program source code, the system comprising:
a) a parser configured to perform a syntactical analysis of the target program source code;
b) type determining means for employing the parser to perform a control flow analysis of the target program source code and determine at least one runtime assignment of a program object to the target program variable, and for each assignment of a program object, determining at least one corresponding candidate type;
c) member determining means for determining, for each candidate type, a corresponding list of one or more members; and
d) executable program code configured to insert each list of members into the completion list.

11. The computer-based system of claim 10, the type determining means including configured to recursively determine the at least one corresponding candidate type by recursively determining a type of an expression assigned to the target program variable.

12. The computer-based system of claim 10, the type determining means comprising means for determining one or more candidate types of the target program variable based on a use of the program variable in an expression.

13. The computer-based system of claim 10, the target program variable is a program function parameter of a program function, the type determining means configured to determine one or more candidate types of the target program variable based on one or more arguments corresponding to the function parameter in one or more invocations of the program function.

14. The computer-based system of claim 10, further comprising means for determining the list of members by loading an assembly and creating an instance of a class defined in the assembly.

15. A computer-readable storage medium comprising computer program instructions for generating a completion list corresponding to a target expression in a target program source code, the program instructions executable by one or more processors to perform actions including:
a) performing a control flow analysis to locate one or more source code instructions that each represent a runtime resolution of an object type corresponding to the target expression;
b) analyzing each of the one or more source code instructions to determine at least one candidate type corresponding to the target expression;
c) for each candidate type, determining a set of class members associated with the type; and
d) aggregating the one or more sets of class members.

16. The computer-readable storage medium of claim 15, the one or more source code instructions including a plurality of instructions each representing a corresponding use of the target expression, determining at least one candidate type comprising analyzing each use of the target expression to determine at least one corresponding type.

17. The computer-readable storage medium of claim 15, the target expression is a program function parameter of a program function, the one or more source code instructions including a plurality of invocations of the program function, each invocation including a respective argument corresponding to the program function parameter, determining at least one candidate type is based on an object type of each corresponding argument.

18. The computer-readable storage medium of claim 15, the target expression is a program variable, the actions further comprising determining that the source code does not include a type declaration of the program variable.

19. The computer-readable storage medium of claim 15, the target expression is a program variable, the one or more source code instructions including at least one instruction representing a runtime assignment of an expression including a function return value to the program variable, determining at least one candidate type comprising analyzing the function to determine at least one corresponding return value type.

20. The computer-readable storage medium of claim 15, the actions further comprising:
a) analyzing program instructions from each of at least two alternative program flows; and
b) determining at least one candidate type from each of the alternative program flows.
